(19) United States
(12) Patent Application Publication
(10) Pub. No.: US 2009/0056145 A1
(43) Pub. Date: Mar. 5, 2009

(54) DOUBLE-BLADED KNIFE

(76) Inventors: Elias A. Alfi, Newbury Park, CA (US); Arik G. Alfi, Tarzana, CA (US); Daniel A. Alfi, Tarzana, CA (US)

Correspondence Address: CHRISTIE, PARKER & HALE, LLP, PO BOX 7068, PASADENA, CA, 91109-7068, US

(21) Appl. No.: 12/053,520

(22) Filed: Mar. 21, 2008

Related U.S. Application Data
(60) Provisional application No. 60/896,220, filed on Mar. 21, 2007.

(51) Int. Cl. B26B 3/06; B26B 3/00

(52) U.S. Cl. 30/151; 30/165

(57) ABSTRACT

A knife has plastic molded body with a handle and distal portion formed with finger-like extensions that hold a blade with its cutting edges exposed. The extensions form an atraumatic profile with the blade to facilitate cutting of an object by the cutting edge. The atraumatic profile extends along a longitudinal direction of the knife and/or a lateral direction of the knife. In one embodiment, the extensions are tapered in both a longitudinal and a lateral direction of the knife, such that there is a smooth transitional region where the extensions and the blade meet. The knife includes a sliding region proximal the cutting edge of the blade which facilitates a swift cutting motion into dough where the extensions follow and functions as part of the blade. The knife also includes a protective cover that is detachable from the knife, or is movable between a position that covers the blade and a position that exposes the blade. The cover can translate or pivot between the two positions by means of pins that engage a slot formed in the handle. The cover can releasably lock in both positions by means of a latch mechanism. The knife may also include an orientation indicator.

### CROSS-REFERENCE TO RELATED APPLICATION(S)

This application claims priority under 35 U.S.C. § 119(e) to U.S. Provisional Application Ser. No. 60/896,220, filed Mar. 21, 2007, the entire contents of which are incorporated by reference herein.

### BACKGROUND

Standard double edge razor blades are commonly used in the food industry for a variety of uses, including the scoring of dough. Dough including bread dough is typically scored shortly before baking to allow gases to escape during the baking process. Scoring therefore facilitates even rising of the dough which minimizes bulging and thus burning, thus producing bread with more visual appeal. However, double edge razor blades can be dangerous to handle, especially where scoring is done quickly in an assembly-line fashion, and they can lead to contamination of the dough such as when a user mishandles the blade and cuts himself. Even worse, blades are sometimes inadvertently left behind in the dough and baked into the bread for the unwitting consumer to discover. Moreover, to a user's naked eye, a dull cutting edge is nearly indistinguishable from a sharp cutting edge. Accordingly, it is desirable for a knife, in particular, a dough scoring knife, to have an extended reach with a generally clean follow-through that is easy and safe to handle. It is also desirable that the knife enables scoring to be performed quickly and efficient without the user having to over analyze the angle and position of the blade. It is further desirable for a knife to provide a visual or tactile indication of its orientation so that a user can better distinguish a dull cutting edge of the blade from the other.

### SUMMARY OF THE INVENTION

A knife of the present invention has body with a handle and distal portion formed with finger-like extensions that hold a blade with its cutting edges exposed. The extensions form an atraumatic profile with the blade to facilitate cutting of an object by the cutting edge. Advantageously, the atraumatic profile extends along a longitudinal direction of the knife and/or a lateral direction of the knife. In one embodiment, the extensions are tapered in both a longitudinal and a lateral direction of the knife, such that there is a smooth transitional region where the extensions and the blade meet.

A knife of present invention includes a sliding region proximal the cutting edge of the blade which facilitates a swift cutting motion into dough with the extensions following and functioning as part of the blade. The knife may include a protective cover that is detachable from the knife, or is movable between a position that covers the blade and a position that exposes the blade. In the latter instance, the cover can translate or pivot between the two positions by means of pins that engage a slot formed in the handle. Moreover, in the latter instance, the cover can releasably lock in both positions by means of a latch mechanism. The knife may also include an orientation indicator. In one embodiment, the indicator is on the handle.

### BRIEF DESCRIPTION OF THE DRAWINGS

These and other features and advantages of the present invention will be better understood by reference to the following detailed description when considered in conjunction with the accompanying drawings wherein:

FIG. 1 is a top view of an embodiment a knife of the present invention, having an oval handle and a planar double-edge razor blade.

FIG. 1a is a view of an embodiment of a double-edge razor blade.

FIG. 2a is a cross sectional view of the knife of FIG. 1 taken at line 2a-2a.

FIG. 2b is a cross sectional view of the knife of FIG. 1 taken at line 2b-2b.

FIG. 3 is a cross sectional view of the knife of FIG. 1 taken along line 3-3.

FIG. 4 is a top view of the knife of FIG. 1 with an embodiment of a movable sheath.

FIG. 4a is an end view of the sheath of FIG. 4.

FIG. 5 is a cross sectional view of an alternative embodiment of a knife of the present invention, having an oval handle and a curved double-edge razor blade.

FIG. 6 is a top view of the knife of FIG. 1 with an embodiment of a detachable cover.

FIG. 6a is a top view of the cover of FIG. 6.

FIG. 6b is a cross sectional view of the cover of 6a, taken along line 6b-6b.

FIG. 7 is a top view of another embodiment of the knife of the present invention, having a contoured elongated handle and a planar double-edge razor blade.

FIG. 7a is a cross sectional view of the knife of FIG. 7, taken along line 7a-7a.

FIG. 7b is a cross sectional view of the knife of FIG. 7, taken along 7b-7b.

FIG. 8 is a top view of yet another embodiment of the knife of the present invention, having a linear elongated handle and a planar double-edge razor blade.

FIG. 8a is a cross sectional view of the knife of FIG. 8, taken along line 8a-8a.

FIG. 8b is a cross sectional view of the knife of FIG. 8, taken along line 8b-8b.

FIG. 9 is a cross sectional view of an embodiment of a knife of the present invention, having an elongated handle and a planar double-edge razor blade.

FIG. 10 is a cross sectional view of an embodiment of a knife of the present invention, having an elongated handle and a curved double-edge razor blade.

FIG. 11a is a top view of an embodiment of a knife of the present invention.

FIG. 11b is a top view of another embodiment of a knife of the present invention.

FIGS. 12a and 12b are cross sectional views of an embodiment of a knife in use.

FIG. 13 is a cross sectional view of dough after scoring.

### DETAILED DESCRIPTION OF THE INVENTION

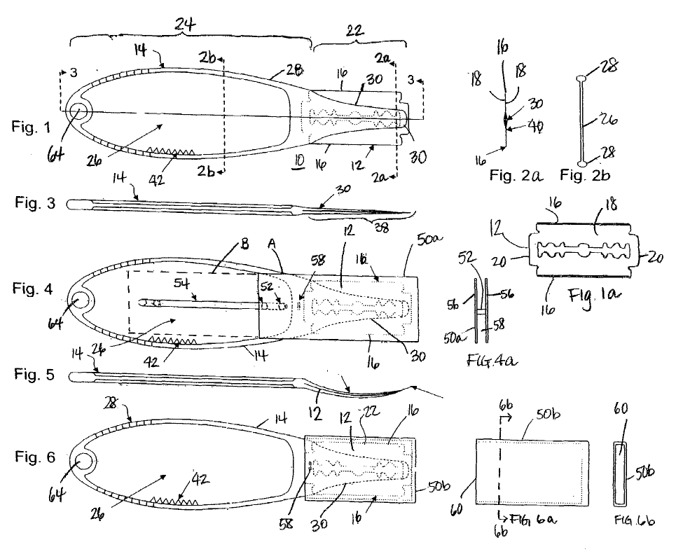

With reference to FIGS. 1-10, the present invention is directed a knife 10 that is adapted primarily for scoring bread dough or the like. Advantageously, the knife 10 has a classic straight, double-edged razor blade 12 (FIG. 1a) that is molded into a plastic body 14 in a fashion such that the blade and the body jointly form an atraumatic profile in two dimensions where at least a portion of the body holding the razor facilitates the cutting function of the razor by both of its cutting edges 16. The blade has two opposite surfaces 18 (FIG. 2a) and two opposing ends 20 (FIG. 1a). With reference to FIG. 1, the blade is held in a distal portion 22 of the body 14, and a proximal portion 24 of the plastic body is generally configured as a handle 26. As better illustrated in FIG. 2b, the handle is generally of a relatively thin, planar configuration with a thicker perimeter 28 so as to facilitate a better grip on the handle by the user and/or to minimize the use of plastic.

In the illustrated embodiments, the distal portion 22 is configured as two finger-like extensions 30 into which the blade 12 is molded. With reference to FIGS. 1 and 2a, the blade is held as such along its longitudinal axis so that both cutting edges 16 remain fully exposed. The extensions 30 define a thickened area that remains near the middle of the blade to support the blade. Advantageously, the extensions 30 in the area of the blade have a tapered profile or area 38 in the longitudinal direction (FIG. 3), as well as a tapered profile or area 40 in the lateral direction (FIG. 2a), such that the distal portion 22 of the knife is atraumatic in two dimensions. In the lateral direction, the extensions 30 gradually thin out toward the cutting edge 16 of the blade to form a region. Where the region meets the blade, its thickness approaches the thickness of the blade so it is almost flush with the blade and is in essence an extension of the blade, in the sense that there is no additional resistance when the blade cuts into dough to the extensions. The region is nearly seamless between the extensions and the blade, such that the extensions become part of the blade as the blade is cutting or scoring. The entire distal portion 22, inclusive of the extensions 30 and the exposed surfaces 18 of the blade, readily passes through the object being cut following the cutting edge 16 of the blade. Except for the cutting edges of the blade, the knife is substantially devoid of sharp edges or formations that can get catch onto the object being cut, for example, dough. The atraumatic configuration of the extensions 30 with the blade 12 therefore provide a generally clean follow-through in the wake of the cutting edge 16.

To help the user distinguish one cutting edge from the other and the orientation of the blade with respect to one cutting edge from the other, such as when on edge becomes dull, a visual or tactile indicator or marking 42 is provided on one or both sides of one lateral half of the handle. as illustrated in FIGS. 1, 4, 6, 7 and 8. It can be a different color from the rest of the handle and/or a raised formation, an indentation, or a combination of both that can be molded as part of the plastic body. Accordingly, when one cutting edge becomes dull, the user can use the indicator to orient his grip on the handle so as to use the other cutting edge. It is understood by one of ordinary skill in the art that the indicator can be molded on any lateral half of the plastic body including the distal portion so long as the distal portion maintains an atraumatic profile with the blade.

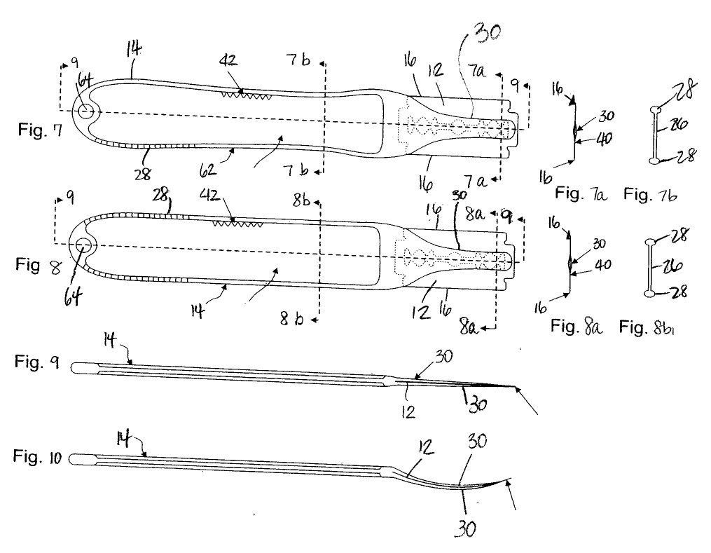

A feature of the present invention is a protective cover 50 for the blade. In one embodiment, as shown in FIG. 4, the cover is a sheath 50a with pins or pegs that are guided by a longitudinal slot in the plastic body. The sheath is generally rectangular and moves between a first position A (solid lines in FIG. 4) that covers the blade for storage and a second position B (broken lines in FIG. 4) that exposes the blade. The sheath includes two generally aligned planar members 56 defining a gap 58 in between with a plurality of guiding pins 52 extending from one member into the gap to ride in and be guided by an elongated linear hollow track or rail 54 along the longitudinal axis of the plastic body. The two pins 52 enable the sheath to translate proximally and distally along the longitudinal axis of the plastic body with minimal lateral motion. However, it is understood by one of ordinary skill in the art that the sheath in another embodiment can also include use a pivoting guiding pin such that the sheath pivots between a first position that exposes the blade and a second position that covers the blade.

In either embodiment, the sheath 50a is molded separately in plastic from the plastic body 14 and is mounted onto the plastic body by inserting the plastic body into the gap 58 between the planar members 56 and sliding the sheath 50a over the plastic body until the pins 52 reach the rail 54 and snap into the rail. Moreover, in either embodiment, the sheath includes a latch mechanism 58 that releasably locks the sheath in both the first and second positions. A suitable construction of the latch mechanism is described in U.S. Pat. No. 6,918,183, the entire disclosure of which is incorporated herein by reference.

In an alternative embodiment, a cover 50b is entirely removable or detachable from plastic body 14. The cover is pushed over the blade and snaps into position by means of a similar latch mechanism. As illustrated in FIGS. 6, 6a and 6b, the cover 50b is a generally rectangular enclosure that has an open proximal end 60 for receiving the distal portion 22 of the knife. Like the sheath 50a, the cover 50b has a stop latch mechanism 58 to releasably lock the cover onto the knife.

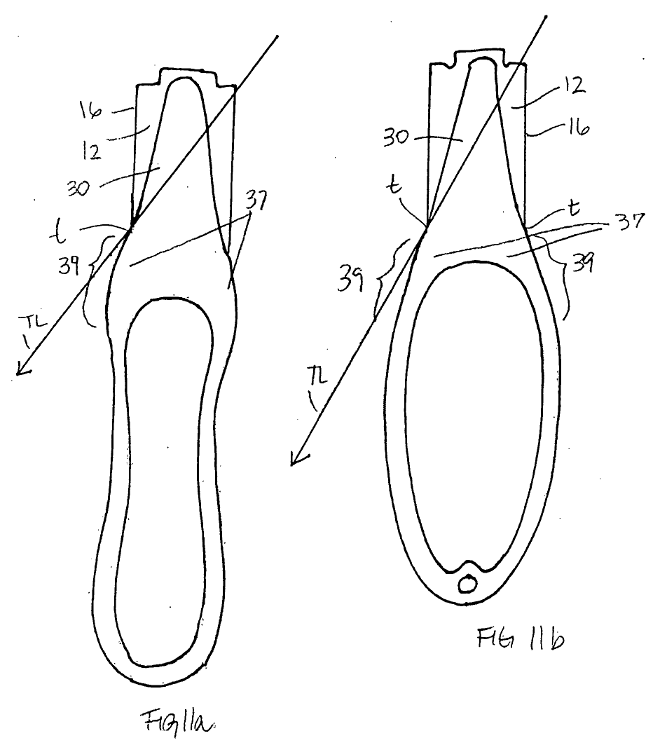

The handle of the knife is linearly elongated (FIG. 7), or elongated with a contoured profile (FIG. 8). In the embodiment of FIG. 8, the profile resembles an hour-glass with a narrower mid-section 62 compared with distal and proximal ends of the handle. Alternatively, the handle may be more oval as shown in FIG. 1. In any case, surface of at least a portion of the perimeter 28 of the handle can be textured to provide a gripping surface for the user. Furthermore, the blade 12 and the extensions 30 holding the blade may be curved as shown in FIGS. 5 and 10. Correspondingly, the cover of FIG. 6 may be curved for use with these embodiments. A curved blade can provide a lifting effect in the dough. Moreover, the curvature of the blade allows the formation of a lid (also referred to as a “lip”) in the dough above the cut such that the lid can lift and drop like a “safety valve” regulating the escape of gases to ensure a controlled rising of the dough.

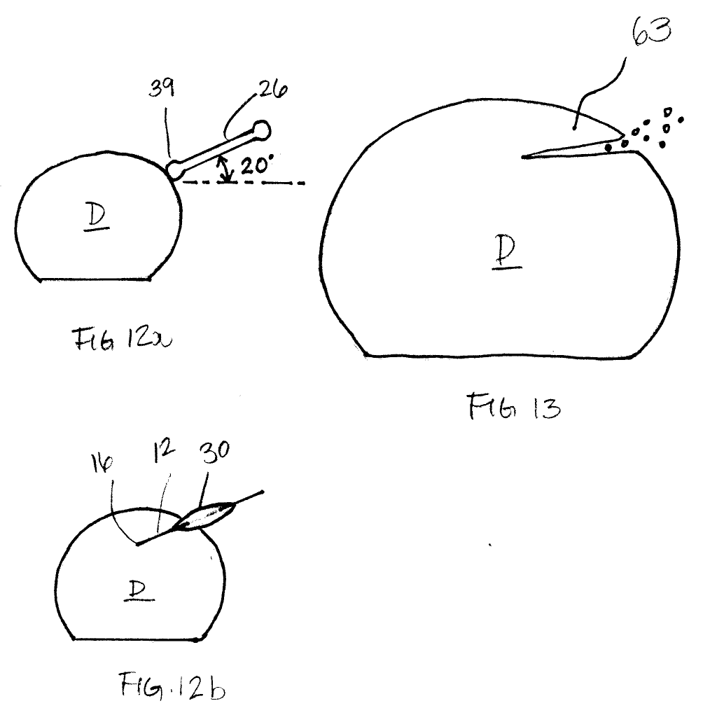

In accordance with another feature of the present invention, a slide region 37 is provided in the plastic body to help guide the user when scoring. (In the illustrated embodiments of FIGS. 1, 7 and 8, the slide region is a distal portion of the handle.) Referring also to FIGS. 11a and 11b, the slide region 37 is situated immediately proximal the blade 12 where it meets the cutting edge 16 of the blade at location t. The slide region 37 has an outer edge 39 that defines a width greater than the width of the blade 12. Moreover, the slide region 37 beginning at location t adopts a rounded outline, departing from the linear outline presented by the cutting edge 16 of the blade 12.

When scoring with the knife 10 with a swift motion, the user may draw the knife toward himself in the direction of tangent line TL while allowing the outer edge 39 of the sliding region 37 to come into contact with dough D. The knife may be held to provide an angle of cut that is typically about 20 degrees, although it can be varied according to individual need (FIG. 12a). As the user continues with the swift motion, the contact location generally migrates distally toward the location t, upon which occurrence the cutting edge 16 of the blade 12 cuts into the dough. As a continuing part of the same swift motion, the extensions 30 follow the blade 12 into the dough (FIG. 112b) functioning as part of the blade until the blade completely passes through the dough. The resulting scoring forms a lip 63 (FIG. 13) that allows gases to escape in a controlled manner to assure proper rising of the dough during the baking process.

An aperture 64 is provided the proximal end of the handle so the knife can be convenient hung on a hook for storage, or on a fastener adapted to hang from the user's apparel, such as a belt.

The preceding description has been presented with reference to presently preferred embodiments of the invention. Workers skilled in the art and technology to which this invention pertains will appreciate that alterations and changes in the described structure may be practiced without meaningfully departing from the principal, spirit and scope of this invention. For example, it is understood that the handle of the knife may be either oval or elongated (with or without contouring) combined with either a planar or curved blade, and that either the cover or the moveable sheath may be adapted for use with any handle or blade configuration

Accordingly, the foregoing description should not be read as pertaining only to the precise structures described and illustrated in the accompanying drawings, but rather should be read consistent with and as support to the following claims which are to have their fullest and fair scope.

What is claimed is:

1. A knife, comprising:
a body with a handle, and a distal portion having extensions; and
a blade positioned between the extensions, the blade have at least one cutting edge;
wherein the extensions form an atraumatic profile with the blade to facilitate cutting of an object by the cutting edge.

2. A knife of claim 1, wherein the atraumatic profile extends along a longitudinal direction of the knife.

3. A knife of claim 1, wherein the atraumatic profile extends along a lateral direction of the knife.

4. A knife of claim 1, wherein the extensions are tapered in both a longitudinal and a lateral direction of the knife.

5. A knife of claim 1, wherein the blade is a double edge razor blade.

6. A knife of claim 1, further comprising a cover.

7. A knife of claim 6, wherein the cover is movable between a first position that covers the cutting edge and a second position that exposes the cutting edge.

8. A knife of claim 7, wherein the cover translates along a longitudinal direction between the first and second positions.

9. A knife of claim 7, wherein the cover is detachable from the knife.

10. A knife of claim 1, further comprising an orientation indicator.

11. A knife of claim 1, wherein the blade is planar.

12. A knife of claim 1, wherein the blade is curved.

13. A knife of claim 7, wherein the handle has a slot and the cover has at least one pin to engage the slot for guiding movement of the cover between the first and second positions.

14. A knife of claim 6, further comprising a latch mechanism to releasably lock the cover in a position on the handle.

15. A knife of claim 1, wherein the handle is generally of an oval configuration.

16. A knife of claim 1, wherein the handle is generally of an elongated linear configuration.

17. A knife of claim 1, wherein the handle is generally of a elongated contoured configuration.

18. A knife of claim 1, wherein the body is of molded plastic.

19. A knife of claim 18, wherein the blade is molded in the plastic.

20. A knife of claim 1, wherein the knife is adapted for scoring dough.

21. A knife of claim 1, further comprising a sliding region proximal at least an exposed cutting edge of the blade.
